(19) United States
(12) Patent Application Publication
(10) Pub. No.: US 2012/0105516 A1
(43) Pub. Date: May 3, 2012

(54) PLASMA DISPLAY PANEL DRIVING METHOD AND PLASMA DISPLAY DEVICE

(75) Inventors: Hidehiko Shoji, Osaka (JP); Takahiko Origuchi, Osaka (JP); Naoyuki Tomioka, Osaka (JP); Takateru Sawada, Osaka (JP)

(73) Assignee: PANASONIC CORPORATION, Osaka (JP)

(21) Appl. No.: 13/383,074

(22) PCT Filed: Jul. 7, 2010
(86) PCT No.: PCT/JP2010/004426

§ 371 Date: Jan. 9, 2012

(30) Foreign Application Priority Data
Jul. 10, 2009 (JP) 2009-163435

(51) Int. Cl. G09G 3/28; G09G 5/10; G09G 5/00

(52) U.S. Cl. 345/691; 345/208; 345/63

(57) ABSTRACT

An image display region is divided into a plurality of partial display regions, the scan electrodes included in each partial display region are classified into two scan electrode groups: a scan electrode group formed of the odd-numbered scan electrodes; and a scan electrode group formed of the even-numbered scan electrodes. Scan pulses are sequentially applied to one scan electrode group, and then scan pulses are sequentially applied to the other scan electrode group. The pulse width of the scan pulses applied to the first through predetermined-number-th scan electrodes belonging to the one scan electrode group is set to be longer than the pulse width of the scan pulses applied to the remaining scan electrodes belonging to the one scan electrode group. The pulse width of the scan pulses applied to the first through predetermined-number-th scan electrodes belonging to the other scan electrode group is set to be longer than the pulse width of the scan pulses applied to the remaining scan electrodes belonging to the other scan electrode group.

### TECHNICAL FIELD

The present invention relates to a driving method for a plasma display panel used in a wall-mounted television or a large monitor, and a plasma display apparatus using the driving method.

### BACKGROUND ART

A plasma display panel (hereinafter referred to as “panel”) has a front substrate and a rear substrate that are faced to each other. The front substrate has a plurality of display electrode pairs each of which is formed of a scan electrode and sustain electrode long in the row direction. The rear substrate has a plurality of data electrodes long in the column direction. A discharge cell is formed at each of the positions where the display electrode pairs intersect with the data electrodes

A subfield method is generally used as a method of driving the panel. In this method, one field period divided into a plurality of subfields, and the subfields in which light is emitted are combined, thereby performing gradation display.

Each subfield has an initializing period, an address period, and a sustain period. In the initializing period, initializing discharge is caused to produce wall charge required for a subsequent address operation on each electrode. In the address period, address discharge is caused selectively in a discharge cell to be displayed, thereby producing wall charge. In the subsequent sustain period, a sustain pulse is alternately applied to the display electrode pairs each of which is formed of a scan electrode and a sustain electrode, sustain discharge is caused in the discharge cell having undergone the address discharge, and the phosphor layer of the corresponding discharge cell is made to emit light, thereby performing image display.

A plasma display apparatus includes a scan electrode driver circuit, a sustain electrode driver circuit, and a data electrode driver circuit in order to drive the panel in that manner. The plasma display apparatus applies a driving voltage waveform to each electrode, and displays an image.

Recently, the definition of the panel has been improved and the screen size thereof has been enlarged, and hence the power consumption of the plasma display apparatus has increased. Especially, the data electrode driver circuit applies an address pulse corresponding to an image signal to each data electrode to cause address discharge in each discharge cell, but can malfunction and damage the image display quality when the power consumption of the data electrode driver circuit exceeds an allowance. In order to prevent this, a circuit element of large allowable loss is required to be used, but the requirement is a main factor of increasing the cost.

As a method of suppressing the power consumption of the data electrode driver circuit without reducing the image display quality, a method is proposed in Patent Literature 1, for example. In this method, the order of the address pulse applied to the data electrodes is changed, the charge/discharge current of the data electrodes is reduced, and the power consumption of the data electrode driver circuit is restricted.

Here, in order to change the order of the address pulse applied to the data electrodes, the order of the scan pulses applied to the scan electrodes also needs to be synchronously changed. In order to achieve the driving method described in Patent Literature 1, for example, the method is practical that switches, based on the image signal to be displayed, between the following processes:
a scan pulse is sequentially applied to n scan electrodes, in the order from the first scan electrode to the n-th scan electrode; and
a scan pulse is sequentially applied to the odd-numbered scan electrodes, and then a scan pulse is sequentially applied to the even-numbered scan electrodes.

While, in a high-definition and large-screen panel, the number of scan electrodes increases and hence the time spent for the address period increases. However, when the time from initializing discharge to address discharge increases, the wall charge required for the address operation reduces to destabilize the address discharge, disadvantageously.

### CITATION LIST

### Patent Literature

[PTL 1] Unexamined Japanese Patent Publication No. H11-282398

### SUMMARY OF THE INVENTION

The present invention provides a driving method for a panel and a plasma display apparatus where a stable address discharge is performed and scan pulses for reducing the electric power of the data electrode driver circuit can be switched even in a high-definition and large-screen panel.

A method for driving a plasma display panel that includes a plurality of discharge cells each of which has a data electrode and a display electrode pair formed of a scan electrode and a sustain electrode, wherein the plasma display panel is driven with a structure of one field including a plurality of subfields each of which has an address period and a sustain period.

The method comprising the steps of:
dividing an image display region into a plurality of partial display regions each having a given number of scan electrodes continuously disposed;
dividing the scan electrodes in each partial display regions into two groups, namely, one group formed of odd-numbered scan electrodes and another group formed of even-numbered scan electrodes,
applying scan pulses sequentially to the one group, and then applying scan pulses sequentially to the another group;
setting a pulse width of scan pulses applied to a first through a given numbered scan electrode of the one group to be longer than a pulse width of scan pulses applied to remaining scan electrodes of the one group, and
   setting a pulse width of scan pulses applied to a first through a given numbered scan electrode of the another group to be longer than a pulse width of scan pulses applied to remaining scan electrodes of the another group.

In the method for driving the panel of the invention, the percentage of the number of discharge cells to be lit may be detected as a partial lighting rate, and a scan pulse may be applied to the partial display regions, firstly to a partial display region of a high partial lighting rate.

A plasma display apparatus of the present invention has the following elements:
a panel that has a plurality of discharge cells including a display electrode pair formed of a scan electrode and a sustain electrode, and a data electrode; and
a driver circuit that forms one field using a plurality of subfields having an address period and a sustain period, and drives the panel.
   The driver circuit includes a plurality of scan integrated circuits (ICs) for applying scan pulses to a predetermined number of scan electrodes arranged continuously, and classifies the scan electrodes driven by one scan IC into two scan electrode groups: a scan electrode group including the odd-numbered scan electrodes; and a scan electrode group including the even-numbered scan electrodes. The scan IC sequentially applies scan pulses to one scan electrode group of the two groups, and then sequentially applies scan pulses to another scan electrode group of the two groups. The pulse width of the scan pulses applied to the first through predetermined-numbered scan electrodes belonging to the one scan electrode group is set to be longer than the pulse width of the scan pulses applied to the remaining scan electrodes belonging to the one scan electrode group. The pulse width of the scan pulses applied to the first through predetermined-numbered scan electrodes belonging to the another scan electrode group is set to be longer than the pulse width of the scan pulses applied to the remaining scan electrodes belonging to the another scan electrode group. This configuration can provide a plasma display apparatus where a stable address discharge can be performed and the scan pulses for reducing the electric power of the data electrode driver circuit can be switched even in a high-definition and large-screen panel.

### BRIEF DESCRIPTION OF DRAWINGS

FIG. 1 is an exploded perspective view of a panel in accordance with an exemplary embodiment of the present invention.

FIG. 2 is an electrode array diagram of the panel.

FIG. 3 is a diagram showing a driving voltage waveform to be applied to each electrode of the panel.

FIG. 4 is a diagram showing the existence of an address pulse in a certain subfield.

FIG. 5 is a diagram for estimating the power consumption of a data electrode driver circuit when address operation is sequentially performed.

FIG. 6 is a diagram for estimating the power consumption of the data electrode driver circuit when a checkered pattern similar to that in FIG. 5 is displayed.

FIG. 7 is a characteristic diagram showing the relationship between the address order of partial display regions and the amplitude of a scan pulse required for causing stable address discharge.

FIG. 8 is a diagram showing the relationship between the partial lighting rate and the amplitude of a scan pulse required for causing stable address discharge.

FIG. 9 is a pattern diagram showing the partial display regions of the panel in accordance with the exemplary embodiment of the present invention.

FIG. 10 is a detailed timing chart showing an example of address operation of a plasma display apparatus in accordance with the exemplary embodiment of the present invention.

FIG. 11 is a circuit block diagram of the plasma display apparatus.

FIG. 12 is a circuit diagram showing the configuration of a scan electrode driver circuit of the plasma display apparatus.

FIG. 13 is a circuit block diagram showing the detail of a scan IC of the plasma display apparatus.

FIG. 14 is a diagram showing the operation of an output control section and a switching element of the scan ICs of the plasma display apparatus.

FIG. 15 is a diagram showing the connection of the scan ICs of the plasma display apparatus.

FIG. 16 is a timing chart for illustrating the operation of a scan IC selecting section of the scan ICs of the plasma display apparatus.

### DESCRIPTION OF EMBODIMENTS

Plasma display apparatuses in accordance with an exemplary embodiment of the present invention will be described hereinafter with reference to the accompanying drawings.

### Exemplary Embodiment

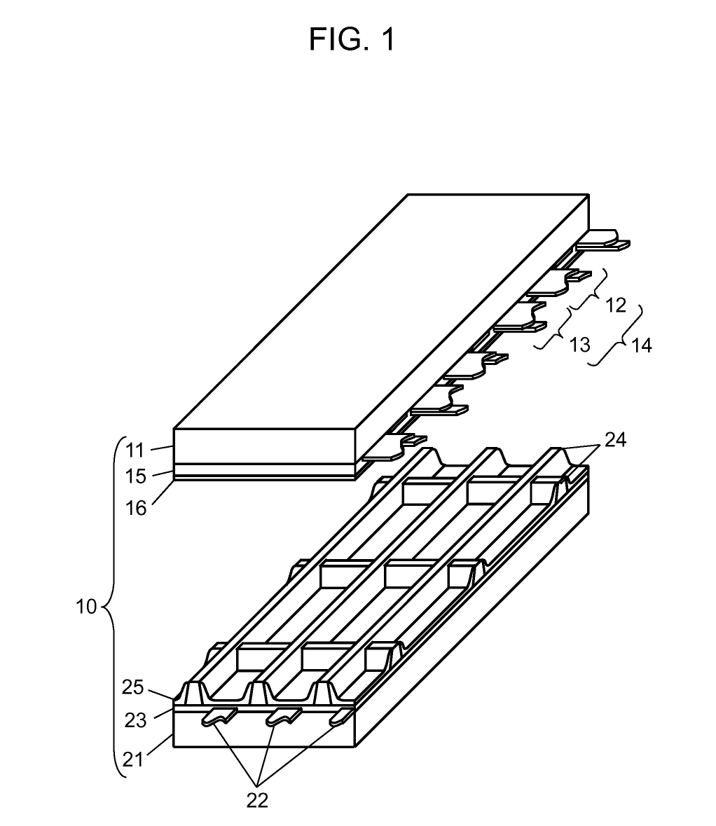

FIG. 1 is an exploded perspective view of panel 10 in accordance with an exemplary embodiment of the present invention. A plurality of display electrode pairs 14 formed of scan electrodes 12 and sustain electrodes 13 is disposed on glass-made front substrate 11. Dielectric layer 15 is formed so as to cover scan electrodes 12 and sustain electrodes 13, and protective layer 16 is formed on dielectric layer 15. A plurality of data electrodes 22 is formed on rear substrate 21, dielectric layer 23 is formed so as to cover data electrodes 22, and mesh barrier ribs 24 are formed on dielectric layer 23. Phosphor layers 25 for emitting lights of red, green, and blue are disposed on the side surfaces of barrier ribs 24 and on dielectric layer 23.

Front substrate 11 and rear substrate 21 are faced to each other so that display electrode pairs 14 cross data electrodes 22 with a micro discharge space sandwiched between them, and the outer peripheries of them are sealed by a sealing material such as glass frit. The discharge space is filled with mixed gas of neon and xenon as discharge gas, for example. The discharge space is partitioned into a plurality of sections by barrier ribs 24. Discharge cells are formed in the intersecting parts of display electrode pairs 14 and data electrodes 22. The discharge cells discharge and emit light to display an image.

The structure of panel 10 is not limited to the above-mentioned one, but may be a structure having striped barrier ribs, for example.

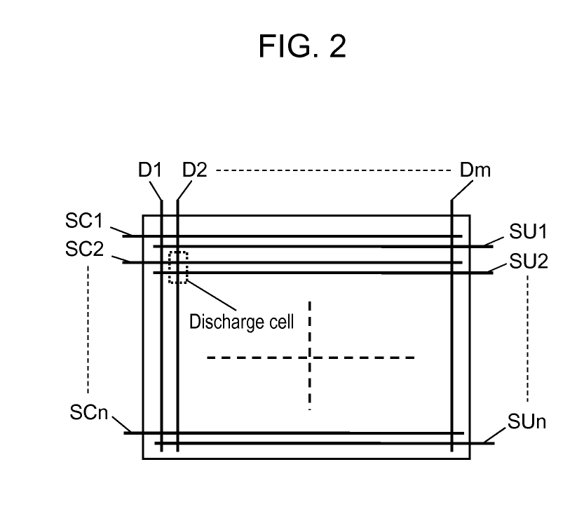

FIG. 2 is an electrode array diagram of panel 10 used in the exemplary embodiment of the present invention. Panel 10 has n scan electrode SC1 through scan electrode SCn (scan electrodes 12 in FIG. 1) and n sustain electrode SU1 through sustain electrode SUn (sustain electrodes 13 in FIG. 1) both extended in the row direction, and m data electrode D1 through data electrode Dm (data electrodes 22 in FIG. 1) extended in the column direction. A discharge cell is formed in the part where a pair of scan electrode SCi (i is 1 through n) and sustain electrode SUi intersect with one data electrode Dj (j is 1 through m). Thus, m×n discharge cells are formed in the discharge space. These discharge cells correspond to the pixels when an image is displayed. The present exemplary embodiment is described assuming that the number of scan electrodes and sustain electrodes is 768, namely n is 768. However, the present invention is not limited to this value.

Next, a driving method for panel 10 of the plasma display apparatus of the present exemplary embodiment is described. Panel 10 performs gradation display by a subfield method, in which one field period is divided into a plurality of subfields, and light emission and no light emission of each discharge cell is controlled in each subfield. Each subfield has an initializing period, an address period, and a sustain period.

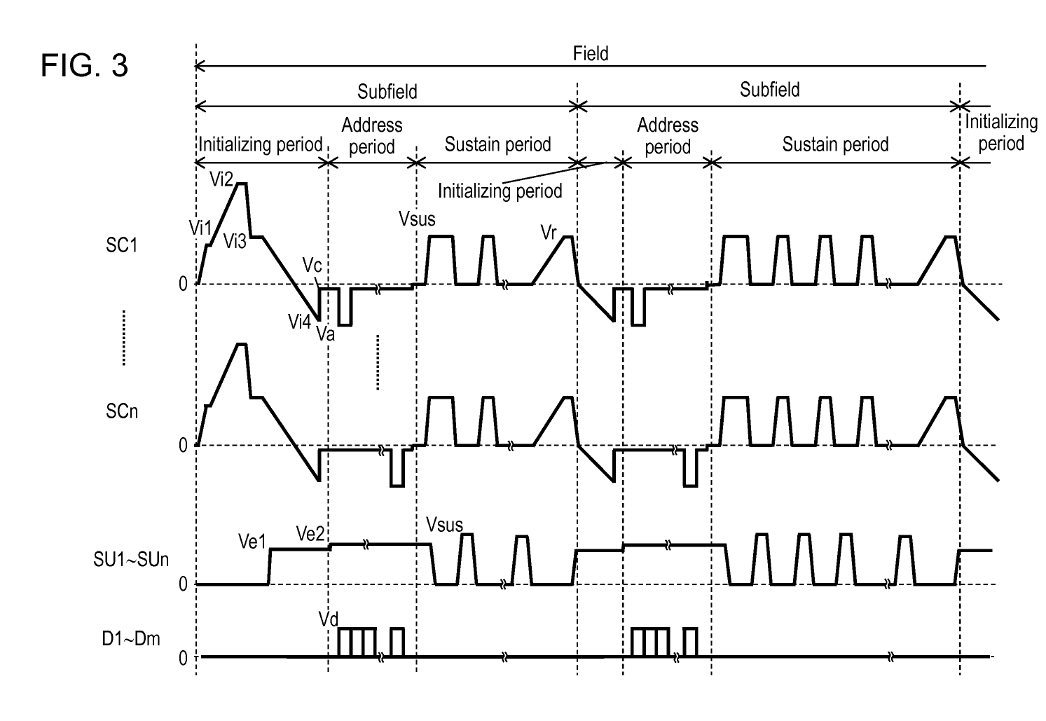

FIG. 3 is a diagram showing a driving voltage waveform to be applied to each electrode of panel 10 used in the exemplary embodiment of the present invention. FIG. 3 shows the driving voltage waveform for two subfields.

In the initializing period of a subfield, voltage 0 (V) is applied to sustain electrode SU1 through sustain electrode SUn, and a ramp voltage, which gently increases from voltage Vi1 to voltage Vi2, is applied to scan electrode SC1 through scan electrode SCn. Then, voltage Ve1 is applied to sustain electrode SU1 through sustain electrode SUn, and a ramp voltage, which gently decreases from voltage Vi3 to voltage Vi4, is applied to scan electrode SC1 through scan electrode SCn. At this time, feeble initializing discharge occurs in each discharge cell to produce wall charge required for the subsequent address operation on each electrode. In the operation in the initializing period, a gently decreasing ramp voltage may be simply applied to scan electrode SC1 through scan electrode SCn, as shown in the initializing period of the second subfield of FIG. 3.

The operation in the subsequent address period is a principal objective of the present invention, but a summary of the address operation is described here. The details thereof are described later.

In the address period, voltage Ve2 is applied to sustain electrode SU1 through sustain electrode SUn, and voltage Vc is applied to scan electrode SC1 through scan electrode SCn. Next, a scan pulse of negative voltage Va is applied to scan electrode SCi where address operation is performed firstly, and an address pulse of positive voltage Vd is applied to data electrode Dk corresponding to the discharge cell to emit light in the row for undergoing address operation firstly. In the discharge cell to which the scan pulse and the address pulse are simultaneously applied, address discharge occurs and the address operation of accumulating wall charge on scan electrode SCi and sustain electrode SUi is performed.

Next, a scan pulse is applied to scan electrode SCj where address operation is performed secondly, and an address pulse is applied to data electrode Dk corresponding to the discharge cell to emit light in the row for undergoing address operation secondly. In the discharge cell to which the scan pulse and the address pulse are simultaneously applied, address discharge occurs and the address operation is performed. The above-mentioned address operation is performed in the discharge cells in all rows, address discharge is selectively caused in the discharge cell to emit light, thereby producing wall charge.

In the subsequent sustain period, voltage 0 (V) is applied to sustain electrode SU1 through sustain electrode SUn, and a sustain pulse of voltage Vsus is applied to scan electrode SC1 through scan electrode SCn. In the discharge cell having undergone the address discharge, sustain discharge occurs to emit light. Then, voltage 0 (V) is applied to scan electrode SC1 through scan electrode SCn, and a sustain pulse of voltage Vsus is applied to sustain electrode SU1 through sustain electrode SUn. In the discharge cell having undergone the sustain discharge, sustain discharge occurs again to emit light.

Hereinafter, similarly, as many sustain pulses as the number corresponding to the luminance weight are alternately applied to scan electrode SC1 through scan electrode SCn and sustain electrode SU1 through sustain electrode SUn. Then, a ramp voltage, which increases to voltage Vr, is applied to scan electrode SC1 through scan electrode SCn, the so-called wall charge erasing is performed, and the sustain period is completed.

Also in the subsequent subfield, operation similar to the operation in the above-mentioned subfield is repeated, thereby making the discharge cell emit light to display an image.

In the present embodiment, voltage values applied to respective electrodes are described as follows. Voltage Vi1 is 145 (V), voltage Vit is 350 (V), voltage Vi3 is 190 (V), voltage Vi4 is −160 (V), voltage Va is −180 (V), voltage Vsus is 190 (V), voltage Vr is 190 (V), voltage Ve1 is 125 (V), voltage Vet is 125 (V), and voltage Vd is 60 (V), for example. Voltage Vc is obtained by adding positive voltage Vscn=145 (V) to negative voltage Va=−180 (V). Therefore, voltage Vc is −35 (V). However, these voltage values are simply an example. Preferably, these voltage values are set optimally in response to the characteristic of panel 10 and the specification of the plasma display apparatus.

Next, the details of the operation in the address period are described. First, a method of suppressing the power consumption of a data electrode driver circuit without reducing the image display quality is described.

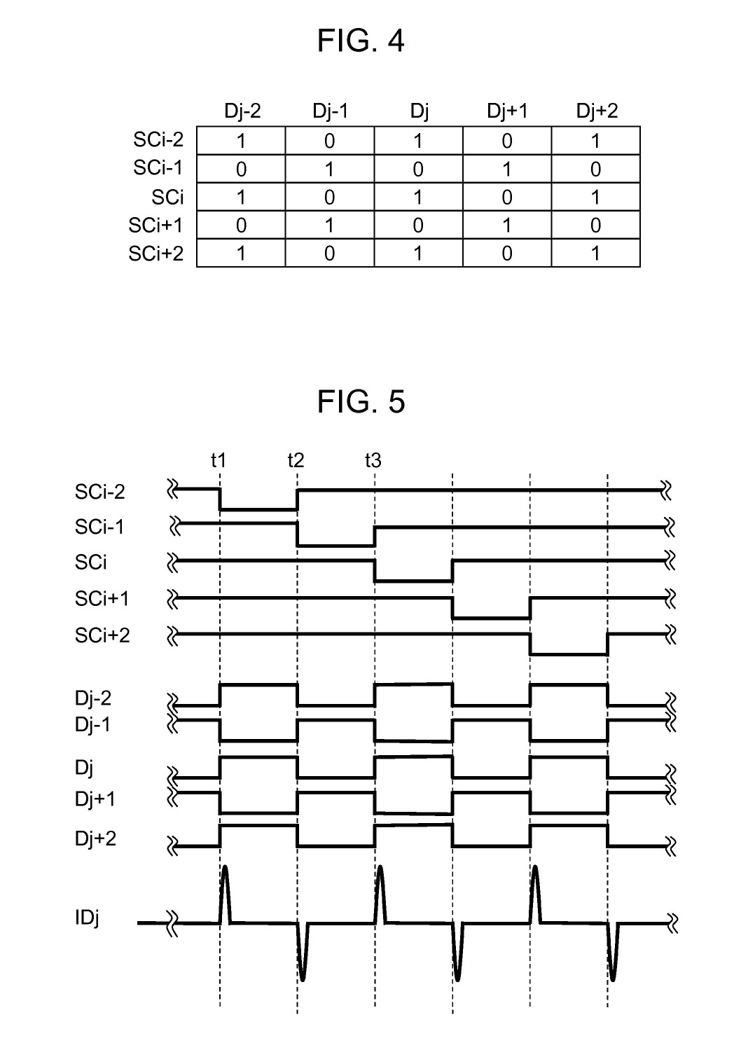

FIG. 4 is a diagram showing the existence of an address pulse in a certain subfield, and shows pixels corresponding to 25 (=5×5) discharge cells. Here, “0” shows the absence of an address pulse, and “1” shows the presence of an address pulse. Such a checkered address pattern is not a special pattern, but even a natural picture or the like is formed by image signal processing such as dither processing. In this checkered address pattern, the power consumption of the data electrode driver circuit largely depends on the applying order of the scan pulse.

FIG. 5 is a diagram for estimating the power consumption of a data electrode driver circuit when address operation (hereinafter referred to as “progressive address operation”) is performed that sequentially applies scan pulses to scan electrode SCi−2, scan electrode SCi−1, scan electrode SCi, scan electrode SCi+1, scan electrode SCi+2, etc. in that order. FIG. 5 shows scan pulses applied to scan electrode SCi−2 through scan electrode SCi+2, address pulses applied to data electrode Dj−2 through data electrode Dj+2, and current waveform IDj flowing in data electrode Dj due to charge and discharge of inter-electrode capacity.

In the period from time t1 to time t2, a scan pulse is applied to scan electrode SCi−2, and address pulses are applied to data electrode Dj−2, data electrode Dj, and data electrode Dj+2, thereby causing address discharge. At this time, no address pulse is applied to data electrode Dj−1 and data electrode Dj+1 not to cause address discharge.

In the period from time t2 to time t3, a scan pulse is applied to scan electrode SCi−1, and address pulses are applied to data electrode Dj−1 and data electrode Dj+1, thereby causing address discharge. At this time, no address pulse is applied to data electrode Dj−2, electrode Dj, and data electrode Dj+2 not to cause address discharge. Hereinafter, similarly, address pulses shown in FIG. 5 are applied.

At this time, current IDj flowing in data electrode Dj is large enough to charge and discharge the inter-electrode capacity between scan electrode SC1 through scan electrode SCn and data electrode Dj and between sustain electrode SU1 through sustain electrode SUn and data electrode Dj. Therefore, the power consumption of the data electrode driver circuit when a checkered pattern is displayed becomes extremely large.

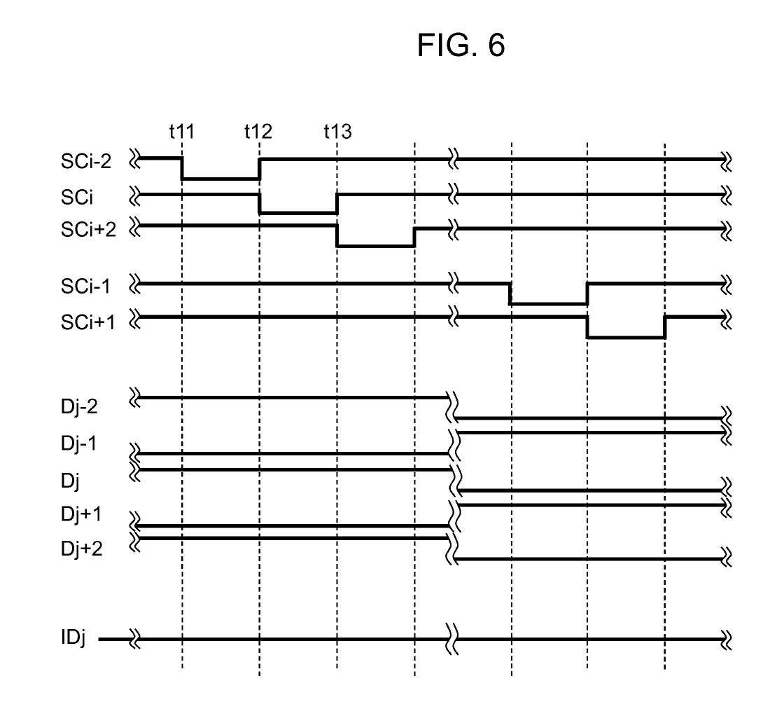

FIG. 6 is a diagram for estimating the power consumption of the data electrode driver circuit when the same checkered pattern as that of FIG. 5 is displayed. FIG. 6 shows a driving voltage waveform and the current waveform of charge/discharge of the inter-electrode capacity in the address period when the address operation (hereinafter referred to as “interlaced address operation”) is performed that applies scan pulses to scan electrode SCi−2, scan electrode SCi, scan electrode SCi+2, . . . , scan electrode SCn−1, scan electrode SC+1, . . . in that order.

In the period from time t11 to time t12, a scan pulse is applied to scan electrode SCi−2, and address pulses are applied to data electrode Dj−2, data electrode Dj, and data electrode Dj+2, thereby causing address discharge. At this time, no address pulse is applied to data electrode Dj−1 and data electrode Dj+1 not to cause address discharge.

In the period from time t12 to time t13, a scan pulse is applied to scan electrode SCi, and address pulses are continuously applied to data electrode Dj−2, data electrode Dj, and data electrode Dj+2, thereby causing address discharge. Hereinafter, similarly, address pulses are continuously applied to data electrode Dj-2, data electrode Dj, and data electrode Dj+2, and no address pulses is continuously applied to data electrode Dj−1 and data electrode Dj+1. Therefore, charge/discharge current does not flow in data electrode Dj, IDj is zero, and hence the power consumption is reduced.

As is clear from this, even when the same pattern is displayed, the power consumption of the data electrode driver circuit largely varies dependently on the applying order of the scan pulses to scan electrode SC1 through scan electrode SCn.

Therefore, by estimating the power consumption when the progressive address operation is performed in each subfield and the power consumption when the interlaced address operation is performed in each subfield and by performing the address operation of smaller electric power, the power consumption of the data electrode driver circuit can be suppressed without reducing the image display quality.

Next, a method of suppressing the wall charge required for the address operation and performing stable address discharge is described. Inventors divide an image display region of the panel into 12 partial display regions including 64 scan electrodes arranged continuously, and perform the following measurement.

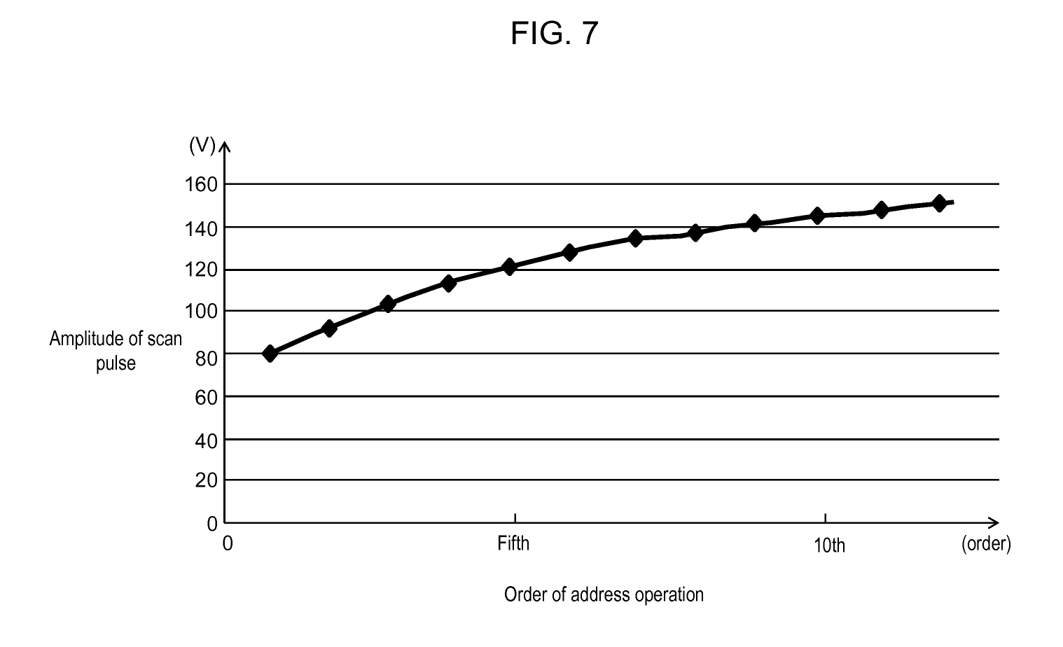

FIG. 7 is a characteristic diagram showing the relationship between the address order of partial display regions and the amplitude of a scan pulse required for causing stable address discharge. The horizontal axis shows the order of the address operation of the partial display regions. The vertical axis shows the amplitude of the scan pulses required for causing stable address discharge. The amplitude of the scan pulses required for causing stable address discharge also varies in response to the address order of the partial display regions. The amplitude of the scan pulses required for causing stable address discharge increases in a partial display region where the address operation is performed later. For example, in the partial display region for performing the address firstly, the amplitude of the scan pulses required for causing stable address discharge is about 80 (V). In the partial display region for performing the address twelfthly, the amplitude of the required scan pulses is about 150 (V), namely about 70 (V) larger than that of the first time.

This is because the wall charge formed in the initializing period gradually decreases with the passage of time. Address pulse voltage is applied to each data electrode according to the display image in the address period, so that the address pulse voltage is applied also to a discharge cell to which no scan pulse is applied. Such voltage variation decreases the wall charge, so that the wall charge further decreases in a discharge cell where address is performed at the end of the address period.

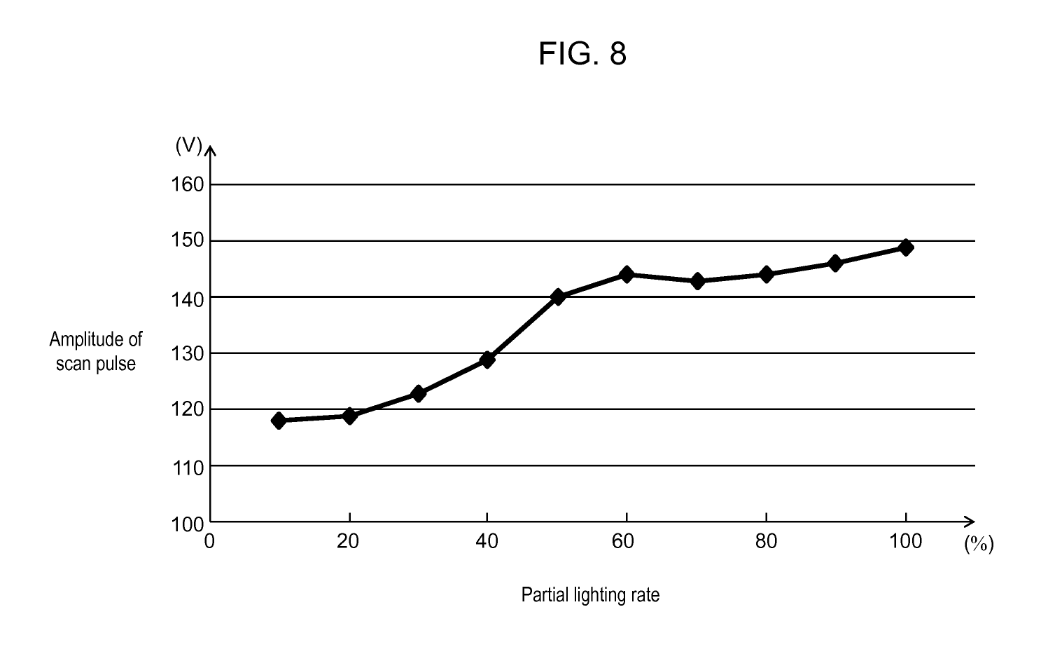

FIG. 8 is a diagram showing the relationship between the lighting rate (hereinafter referred to as “partial lighting rate”) of the partial display region and the amplitude of the scan pulse required for causing stable address discharge. The horizontal axis shows the partial lighting rate, and the vertical axis shows the amplitude of the scan pulse required for causing stable address discharge. This relationship is obtained by measuring the variation of the amplitude of the scan pulses required for causing stable address discharge while varying the percentage of the lighting cells in one partial display region.

Thus, the amplitude of the scan pulse required for causing stable address discharge depends on the partial lighting rate. The amplitude of the scan pulse increases as the partial lighting rate increases. For example, the amplitude of the required scan pulse is about 118 (V) at a partial lighting rate of 10%, and the amplitude of the required scan pulse is about 149 (V) at a partial lighting rate of 100%. Namely, the amplitude at 100% is about 31 (V) larger than that at 10%.

This is because, as the partial lighting rate increases, the discharge current increases and the voltage drop for the scan pulse increases. This trend is further increased by enlargement of the screen of the panel.

Thus, the amplitude of the scan pulse required for causing stable address discharge increases as the address operation is performed at a later time, and increases as the partial lighting rate increases. When the partial display region is scanned at a later time and the partial lighting rate in the partial display region is high, the amplitude of the required scan pulse further increases. In other words, these experimental results indicate that, when the address operation is performed in the partial display regions, firstly in the partial display region of the highest partial lighting rate, the stable address discharge can be performed while the amplitude of the scan pulse is suppressed.

In the present embodiment, in order to reconcile suppressing of power consumption with stable address discharge in the data electrode driver circuit, the following processes are performed:
the image display region of panel 10 is divided into a plurality of partial display regions including a predetermined number of scan electrodes arranged continuously;
the partial lighting rate of each partial display region is detected; and
scan pulses are applied to the partial display regions, firstly to the partial display region of the highest partial lighting rate.
   The power consumption when the progressive address operation is performed and the power consumption when the interlaced address operation is performed are estimated, and one of the progressive address operation and interlaced address operation is selected so as to decrease the power consumption in each partial display region.

Next, the details of the address operation in the present embodiment are described using an example.

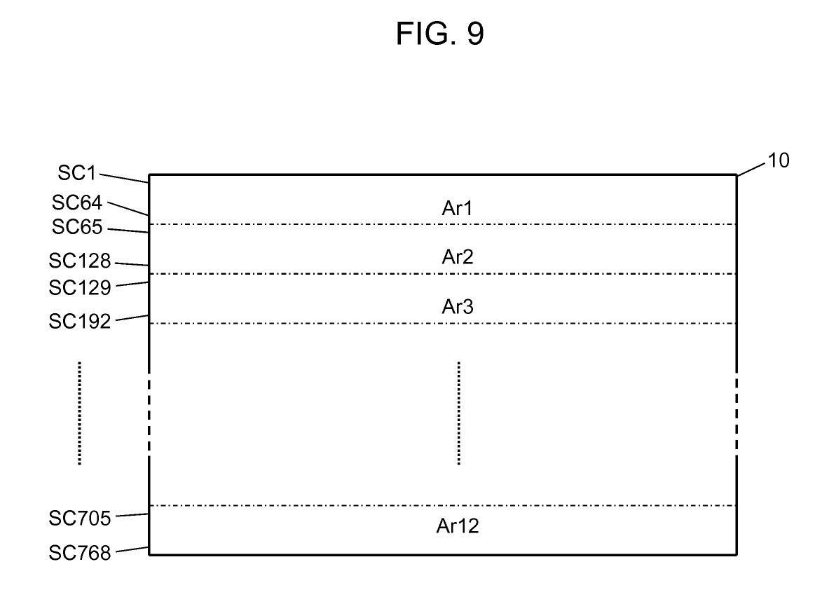

FIG. 9 is a pattern diagram showing the partial display regions of panel 10 in accordance with the exemplary embodiment of the present invention. The image display region of panel 10 is divided into 12 partial display region Ar1 through partial display region Ar12 each of which includes 64 (the predetermined number) scan electrodes arranged continuously. In other words, partial display region Ar1 includes scan electrode SC1 through scan electrode SC64, partial display region Ar2 includes scan electrode SC65 through scan electrode SC128, partial display region Ar12 includes scan electrode SC705 through scan electrode SC768.

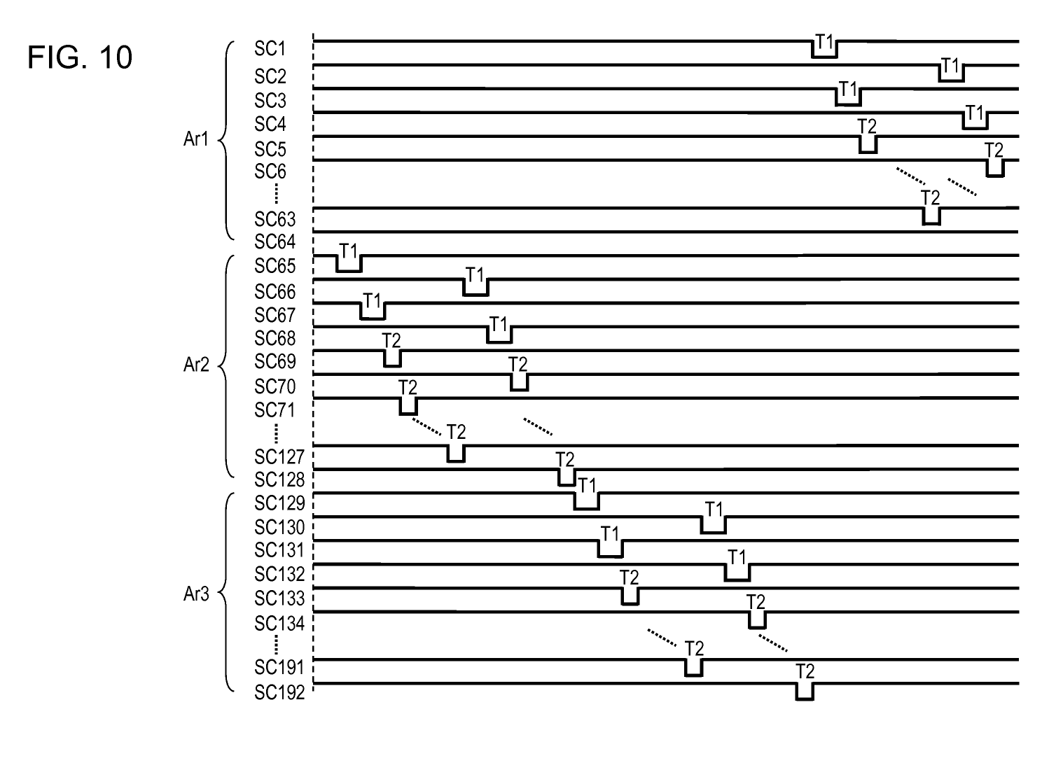

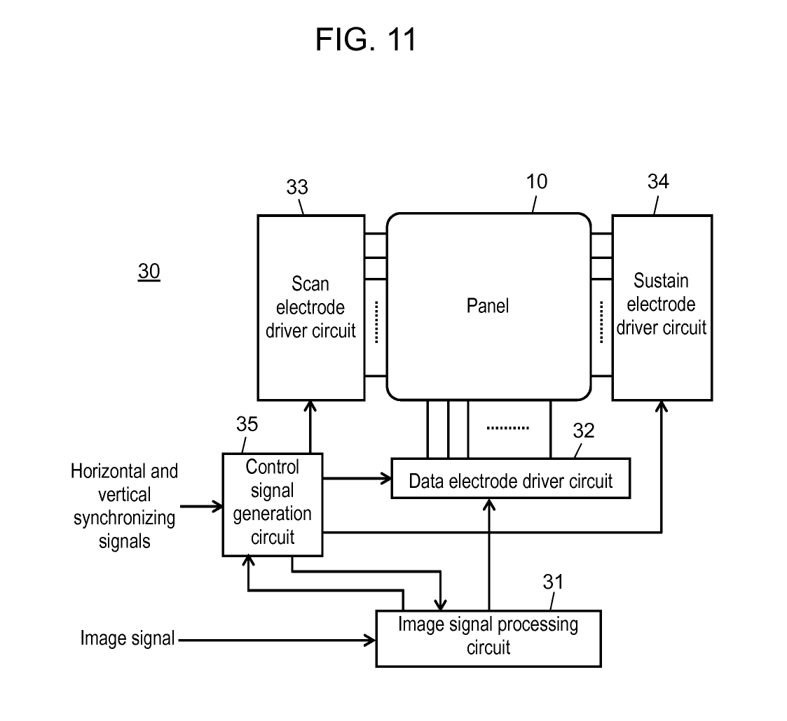

FIG. 10 is a detailed timing chart showing an example of address operation of a plasma display apparatus in accordance with the exemplary embodiment of the present invention. FIG. 10 shows an example where the partial lighting rate of partial display region Ar2 is the highest, the partial lighting rate of partial display region Ar3 is the second-highest, and the partial lighting rate of partial display region Ar1 is the third-highest. In this example, dither processing is performed in partial display region Ar1 through partial display region Ar3, and the interlaced address operation is performed in these partial display regions.

Scan electrode SC65 through scan electrode SC128 included in partial display region Ar2 are classified into two scan electrode groups: scan electrode group (2 od) formed of the odd-numbered scan electrodes; and scan electrode group (2 ev) formed of the even-numbered scan electrodes. A scan pulse is applied to scan electrode SC65, which is the first scan electrode of scan electrode group (2 od). The pulse width of the scan pulse at this time is time T1. Next, a scan pulse is applied to second scan electrode SC67 of scan electrode group (2 od). The pulse width of the scan pulse at this time is also time T1. Next, a scan pulse is applied to third scan electrode SC69 of scan electrode group (2 od). The pulse width of the scan pulse at this time is time T2 shorter than time T1. Hereinafter, scan pulses are sequentially applied to scan electrode SC71, scan electrode SC73, scan electrode SC75, . . . , and scan electrode SC127 of scan electrode group (2 od). The pulse width of the scan pulse at this time is also time T2.

Next, a scan pulse whose pulse width is time T1 is applied to scan electrode SC66, which is the first scan electrode of scan electrode group (2 ev) formed of the even-numbered scan electrodes in partial display region Ar2. Then, a scan pulse whose pulse width is time T1 is applied to second scan electrode SC68 of scan electrode group (2 ev). Then, a scan pulse whose pulse width is time T2 shorter than time T1 is applied to third scan electrode SC70 of scan electrode group (2 ev). Hereinafter, scan pulses whose pulse width is time T2 are sequentially applied to scan electrode SC72, scan electrode SC74, scan electrode SC76, . . . , and scan electrode SC128 of scan electrode group (2 ev).

Next, scan electrode SC129 through scan electrode SC192 included in partial display region Ar3 are classified into two scan electrode groups: scan electrode group (3 od) formed of the odd-numbered scan electrodes; and scan electrode group (3 ev) formed of the even-numbered scan electrodes. A scan pulse whose pulse width is time T1 is applied to scan electrode SC129, which is the first scan electrode of scan electrode group (3 od), and then a scan pulse whose pulse width is time T1 is applied to scan electrode SC131. Then, a scan pulse whose pulse width is time T2 shorter than time T1 is applied to third scan electrode SC133 of scan electrode group (3 od). Hereinafter, scan pulses whose pulse width is time T2 are sequentially applied to scan electrode SC135, scan electrode SC137, . . . , and scan electrode SC191 of scan electrode group (3 od).

Next, a scan pulse whose pulse width is time T1 is applied to scan electrode SC130, which is the first scan electrode of scan electrode group (3 ev) formed of the even-numbered scan electrodes in partial display region Ar3. Then, a scan pulse whose pulse width is time T1 is applied to second scan electrode SC132 of scan electrode group (3 ev). Then, scan pulses whose pulse width is time T2 shorter than time T1 are sequentially applied to scan electrode SC134, scan electrode SC136, scan electrode SC138, . . . , and scan electrode SC192 of scan electrode group (3 ev).

A similar operation is performed in partial display region Ar1. Scan pulses whose pulse width is time T1 are applied to first scan electrode SC1 and second scan electrode SC3 of scan electrode group (1 od). Scan pulses whose pulse width is time T2 shorter than time T1 are sequentially applied to subsequent scan electrode SC5, scan electrode SC7, . . . , and scan electrode SC63. Next, scan pulses whose pulse width is time T1 are applied to first scan electrode SC2 and second scan electrode SC4 of scan electrode group (1 ev). Scan pulses whose pulse width is time T2 shorter than time T1 are sequentially applied to subsequent scan electrode SC6, scan electrode SC8, . . . , and scan electrode SC64.

Thus, in the present embodiment, the percentage of the number of discharge cells to be lit is detected as a partial lighting rate in each partial display region, and scan pulses are applied to the partial display regions, firstly to the partial display region of the highest partial lighting rate.

The scan electrodes included in each partial display region are classified into two scan electrode groups: a scan electrode group formed of the odd-numbered scan electrodes; and a scan electrode group formed of the even-numbered scan electrodes. Scan pulses are sequentially applied to one scan electrode group, and then scan pulses are sequentially applied to the other scan electrode group. Time T1 as the pulse width of the scan pulses applied to the first through predetermined-number-th (second, in the present embodiment) scan electrodes belonging to the one scan electrode group is set to be longer than time T2 as the pulse width of the scan pulse applied to the remaining scan electrodes belonging to the one scan electrode group. Similarly, time T1 as the pulse width of the scan pulses applied to the first through predetermined-number-th (second, in the present embodiment) scan electrodes belonging to the other scan electrode group is set to be longer than time T2 as the pulse width of the scan pulses applied to the remaining scan electrodes belonging to the other scan electrode group. In the present embodiment, time T1 as the pulse width is 1.3 μs, and time T2 as the pulse width is 1.0 μs. The reason why the pulse widths of the scan pulses are controlled is described as below.

As shown in FIG. 4, when discharge cells applied with address pulses and discharge cells applied with no address pulse are alternately arranged, the current consumption can be suppressed by the interlaced address operation. This is because the charge/discharge current of the data electrodes can be reduced by performing the address operation temporally separately in the discharge cells applied with address pulses and in the discharge cells applied with no address pulse. However, large charge/discharge current instantaneously flows in the data electrodes when the address operation is switched from the odd-numbered scan electrodes to the even-numbered scan electrodes and when the address operation is switched from the even-numbered scan electrodes to the odd-numbered scan electrodes.

When the large charge/discharge current at this time reduces voltage Vd of the address pulse, the discharge delay time of the address discharge can increase. When the discharge delay time is longer than the pulse width of the scan pulse, the address discharge does not occur and light is not emitted in the discharge cell to emit light, and hence the image display quality reduces.

In the present embodiment, however, the pulse width of the scan pulses applied to the first through predetermined-number-th scan electrodes belonging to one scan electrode group is set to be longer than the pulse width of the scan pulses applied to the remaining scan electrodes belonging to the one scan electrode group. Similarly, the pulse width of the scan pulses applied to the first through predetermined-number-th scan electrodes belonging to the other scan electrode group is set to be longer than the pulse width of the scan pulses applied to the remaining scan electrodes belonging to the other scan electrode group. Therefore, the address discharge can be caused even when the discharge delay time of the address discharge becomes large to some extent, so that the reduction in image display quality can be prevented.

In the present embodiment, time T1 as the pulse width of the scan pulses applied to the first through predetermined-number-th scan electrodes belonging to a certain scan electrode group is set to 1.3 μs. Time T2 as the pulse width of the scan pulses applied to the remaining scan electrodes is set to 1.0 μs. The predetermined-number-th scan electrode is set as the second scan electrode. Preferably, these values are set optimally in response to the specification or the like of the panel and the plasma display apparatus. When the capacity of the power supply for generating voltage Vd is small, the predetermined-number-th is set to be large, for example, fifth.

Next, a driver circuit for the plasma display apparatus of the present embodiment is described.

FIG. 11 is a circuit block diagram of plasma display apparatus 30 in accordance with the exemplary embodiment of the present invention. Plasma display apparatus 30 has panel 10 and a driver circuit. The driver circuit includes the following elements:
image signal processing circuit 31;
data electrode driver circuit 32;
scan electrode driver circuit 33;
sustain electrode driver circuit 34;
control signal generation circuit 35; and
a power supply circuit (not shown) for supplying required power to each circuit block.

Image signal processing circuit 31 converts an image signal into an image signal having the number of pixels and gradation level capable of being displayed on panel 10, and converts the light emission or no light emission in each subfield into image data corresponding to respective bits “1” and “0” of a digital signal. Data electrode driver circuit 32 converts the image data into an address pulse corresponding to each of data electrode D1 through data electrode Dm, and applies it to each of data electrode D1 through data electrode Dm.

Control signal generation circuit 35 generates various control signals for controlling operations of respective circuit blocks based on a horizontal synchronizing signal and a vertical synchronizing signal, and supplies the control signals to respective circuit blocks. Control signal generation circuit 35 detects the percentage of the number of discharge cells to be lit as a partial lighting rate in each partial display region, and determines the order of the partial display regions applied with a scan pulse. Control signal generation circuit 35 estimates the power consumption when the progressive address operation is performed and the power consumption when the interlaced address operation is performed, and determines whether the progressive address operation is performed or the interlaced address operation is performed. In addition, control signal generation circuit 35 determines the pulse widths of the scan pulses.

Scan electrode driver circuit 33 generates a driving voltage waveform based on the control signal, and applies it to each of scan electrode SC1 through scan electrode SCn. Especially, scan electrode driver circuit 33 generates scan pulses of the pulse widths responsive to the control signal, and applies the scan pulses to scan electrode SC1 through scan electrode SCn in the order responsive to the control signal. Sustain electrode driver circuit 34 generates a driving voltage waveform based on the control signal, and applies it to sustain electrode SU1 through sustain electrode SUn.

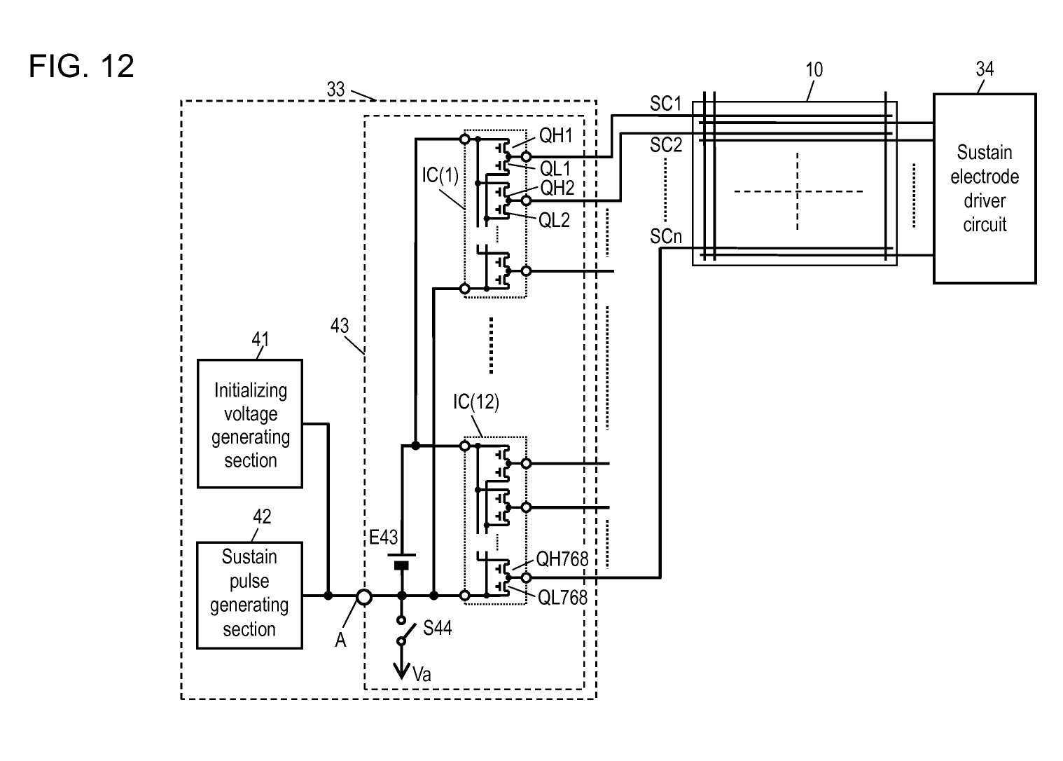

FIG. 12 is a circuit diagram of scan electrode driver circuit 33 of plasma display apparatus 30 in accordance with the exemplary embodiment of the present invention. Scan electrode driver circuit 33 has initializing voltage generating section 41, sustain pulse generating section 42 on the scan electrode side, and scan pulse generating section 43. Each output part from scan pulse generating section 43 is connected to each of scan electrode SC1 through scan electrode SCn of panel 10.

Scan pulse generating section 43 includes the following elements:
switch S44 for connecting reference potential A of scan pulse generating section 43 to negative voltage Va;
power supply E43 for adding voltage Vscn to reference potential A;
switching element QH1 through switching element QHn for outputting voltage on the high voltage side of power supply E43 to n scan electrode SC1 through scan electrode SCn, respectively; and
switching element QL1 through switching element QLn for outputting voltage on the low voltage side of power supply E43.
   Switching element QH1 through switching element QHn and switching element QL1 through switching element QLn are classified into a plurality of groups each of which has a plurality of output parts, and each group is integrated into an IC. These ICs are scan ICs. Scan electrode driver circuit 33 has a plurality of scan ICs for generating scan pulses applied to scan electrode SC1 through scan electrode SCn.

In the present embodiment, the switching elements corresponding to 64 output parts are integrated as one monolithic IC. Scan pulse generating section 43 is formed using 12 scan ICs (hereinafter referred to as “IC(1), IC(2), IC(3), IC(4), IC(5), IC(6), IC(7), IC(8), IC(9), IC(10), IC(11), IC(12)”), and n scan electrode SC1 through scan electrode SCn (n is 768) are driven. IC(1) drives scan electrode SC1 through scan electrode SC64 belonging to partial display region Ar1, IC(2) drives scan electrode SC65 through scan electrode SC128 belonging to partial display region Art. Hereinafter, similarly, IC(12) drives scan electrode SC705 through scan electrode SC768 belonging to partial display region Ar12. Thus, when many switching element QH1 through switching element QHn and switching element QL1 through switching element QLn are integrated, the circuit can be made compact, the mounting area can be reduced, and the cost can be reduced.

Initializing voltage generating section 41 increases or decreases reference potential A of scan pulse generating section 43 in a ramp shape in the initializing period, and generates a driving voltage waveform for the initializing period. At this time, when switching element QH1 through switching element QHn of scan pulse generating section 43 are set at OFF, and switching element QL1 through switching element QLn are set at ON, initializing waveform voltage is applied to scan electrode SC1 through scan electrode SCn via switching element QL1 through switching element QLn. When switching element QH1 through switching element QHn are set at ON, and switching element QL1 through switching element QLn are set at OFF, voltage obtained by adding voltage Vscn of power supply E43 to the initializing waveform voltage is applied to scan electrode SC1 through scan electrode SCn via power supply E43 and switching element QH1 through switching element QHn.

Sustain pulse generating section 42 generates a sustain pulse by setting reference potential A of the input of scan pulse generating section 43 at voltage Vsus or a ground potential. At this time, when switching element QH1 through switching element QHn of scan pulse generating section 43 are set at OFF, and switching element QL1 through switching element QLn are set at ON, a sustain pulse is applied to scan electrode SC1 through scan electrode SCn via switching element QL1 through switching element QLn.

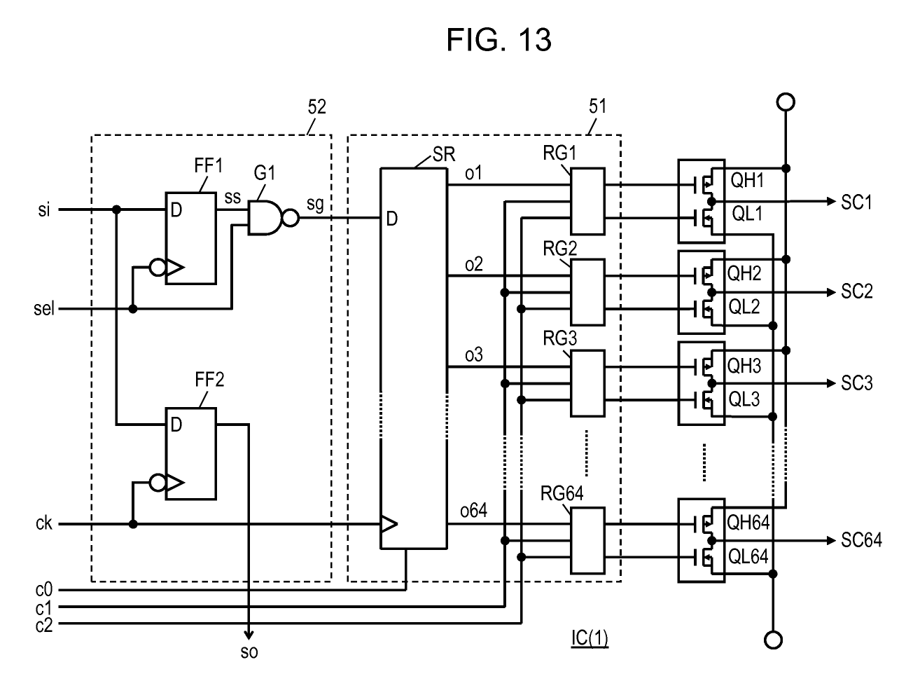

FIG. 13 is a circuit block diagram showing the details of a scan IC of plasma display apparatus 30 in accordance with the exemplary embodiment of the present invention. The first scan IC for driving scan electrode SC1 through scan electrode SC64, namely IC(1), has switching element QH1 through switching element QH64 and switching element QL1 through switching element QL64 for outputting scan pulse voltage, as discussed above. IC(1) has switching element control section 51 for controlling switching element QH1 through switching element QH64 and switching element QL1 through switching element QL64, and scan IC selecting section 52 for determining the order of the address operation of the scan ICs.

Switching element control section 51 has output control section RG1 through output control section RG64 and shift resistor SR. Shift resistor SR has a data input terminal, a clock input terminal, a control signal input terminal, and 64 output terminals, and outputs 64 signal 01 through signal 064 generating a scan pulse to output control section RG1 through output control section RG64, respectively. Control signal c0 is used for selecting one of the progressive address operation and the interlaced address operation. When control signal c0 is at a low level (hereinafter referred to as “L”), switching element control section 51 sequentially shifts single pulse signal sg having a pulse width including one rising of clock ck whenever clock ck is input, and outputs it to output control section RG1 through output control section RG64 in the following order: output control section RG1, output control section RG2, output control section RG3, . . . , output control section RG64. When control signal c0 is at a high level (hereinafter referred to as “H”), switching element control section 51 sequentially shifts single pulse signal sg having a pulse width including one rising of clock ck whenever clock ck is input, and outputs it to output control section RG1 through output control section RG64 in the following order: output control section RG1, output control section RG3, output control section RG5, . . . , output control section RG63, output control section RG2, output control section RG4, output control section RG6, . . . , output control section RG64.

Output control section RG1 receives two control signal c1 and control signal c2 and output signal o1 of shift resistor SR, and controls switching element QH1 and switching element QL1. Output control section RG2 receives two control signal c1 and control signal c2 and output signal o2 of shift resistor SR, and controls switching element QH2 and switching element QL2. Output control section RG3 through output control section RG64 operate similarly.

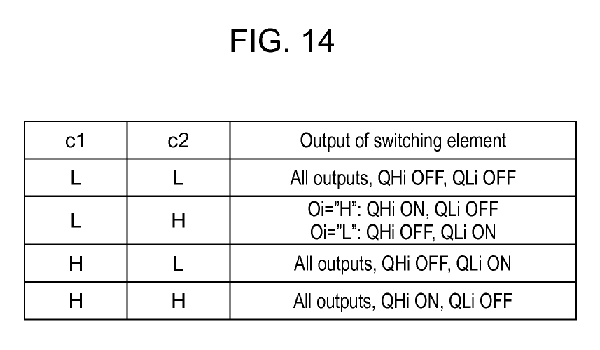

FIG. 14 is a diagram showing the operation of output control section RG1 through output control section RG64, switching element QH1 through switching element QH64, and switching element QL1 through switching element QL64 of the scan IC of plasma display apparatus 30 in accordance with the exemplary embodiment of the present invention. Switching element QH1 through switching element QH64 and switching element QL1 through switching element QL64 are controlled in response to two control signal c1 and control signal c2 in the following manner. When both control signal c1 and control signal c2 are at “L”, both switching element QHi and switching element QLi are set at OFF, and the output is put into a high impedance state. When control signal c1 is at “L” and control signal c2 is at “H”, switching element QHi and switching element QLi are controlled according to the output of corresponding shift resistor SR. In the present embodiment, when output oi of shift resistor SR is at “H”, switching element QHi is set at ON and switching element QLi is set at OFF. When output oi of shift resistor SR is at “L”, switching element QHi is set at OFF and switching element QLi is set at ON. When control signal c1 is at “H” and control signal c2 is at “L”, switching element QHi is set at OFF and switching element QLi is set at ON regardless of the output of shift resistor SR. When both control signal c1 and control signal c2 are at “H”, switching element QHi is set at ON and switching element QLi is set at OFF regardless of the output of corresponding shift resistor SR.

Scan IC selecting section 52 has two flip flops FF1 and FF2 and NAND gate G1. Flip flop FF1 is a general flip flop having a data input terminal, a clock input terminal, and an output terminal. Flip flop FF1 extracts selection scan signal si that is input into the data input terminal with a falling timing of selection signal sel that is input into the clock input terminal, and outputs it to NAND gate G1. NAND gate G1 outputs signal sg obtained by inverting the logical multiplication of output signal ss of flip flop FF1 and selection signal sel to the data input terminal of shift resistor SR.

Flip flop FF2 has the same configuration as flip flop FF1. Selection scan signal si is input into the data input terminal, and clock ck is input into the clock input terminal. Flip flop FF2 outputs delay signal so that is one clock later than selection scan signal si.

IC(2) through IC(12) have a similar configuration.

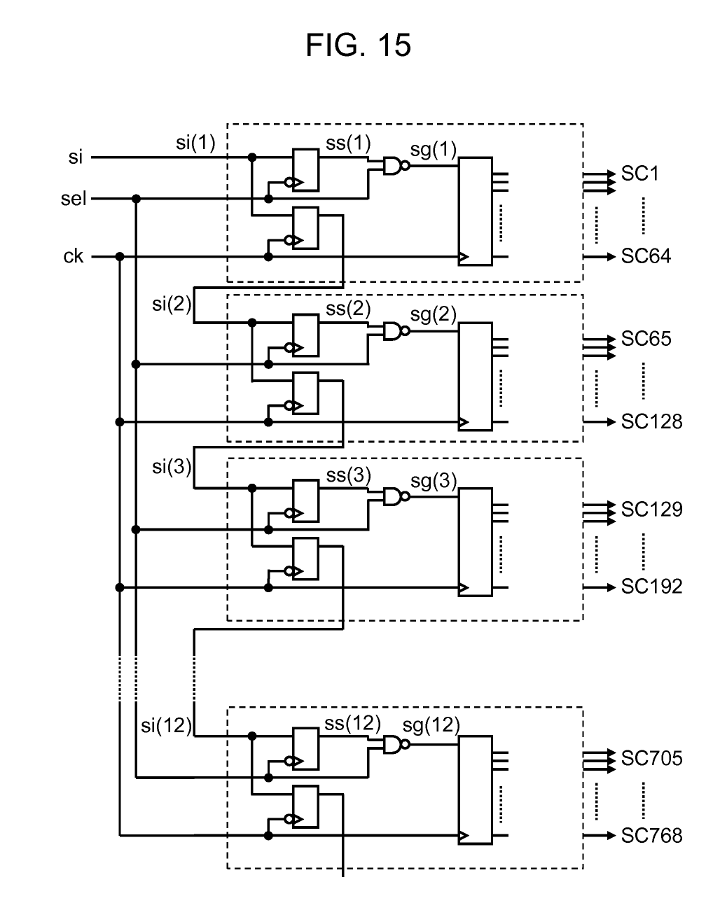

FIG. 15 is a diagram showing the connection of scan IC(1) through IC(12) of plasma display apparatus 30 in accordance with the exemplary embodiment of the present invention. Control signal c0, control signal c1, control signal c2, selection signal sel, and clock ck are commonly input into each of 12 scan ICs (IC(1) through IC(12)) (control signal c0, control signal c1, and control signal c2 are not shown). However, selection scan signal si is input into only first scan IC, namely IC(1). IC(1) receives delay signal so(1) delayed by one clock cycle as address selection scan signal si(2) of the second scan IC, namely IC(2). Hereinafter, similarly, delay signal so(2) of IC(2) is input as selection scan signal si(3) of IC(3), delay signal so(3) of IC(3) is input as selection scan signal si(4) of IC(4), delay signal so(4) of IC(4) is input as selection scan signal si(5) of IC(5), delay signal so(5) of IC(5) is input as selection scan signal si(6) of IC(6), delay signal so(6) of IC(6) is input as selection scan signal si(7) of IC(7), delay signal so(7) of IC(7) is input as selection scan signal si(8) of IC(8), delay signal so(8) of IC(8) is input as selection scan signal si(9) of IC(9), delay signal so(9) of IC(9) is input as selection scan signal si(10) of IC(10), delay signal so(10) of IC(10) is input as selection scan signal si(11) of IC(11), and delay signal so(11) of IC(11) is input as selection scan signal si(12) of IC(12). The 12 scan ICs are connected in a cascade manner so that selection scan signal si is thus transmitted to IC(1) through IC(12) sequentially while delay is developed by one clock cycle.

Scan ICs are thus connected in parallel with respect to control signal c0, control signal c1, control signal c2, selection signal sel, and clock ck, and are connected in a cascade manner with respect to selection scan signal si. One scan IC is selected from 12 scan ICs at random to generate a scan pulse.

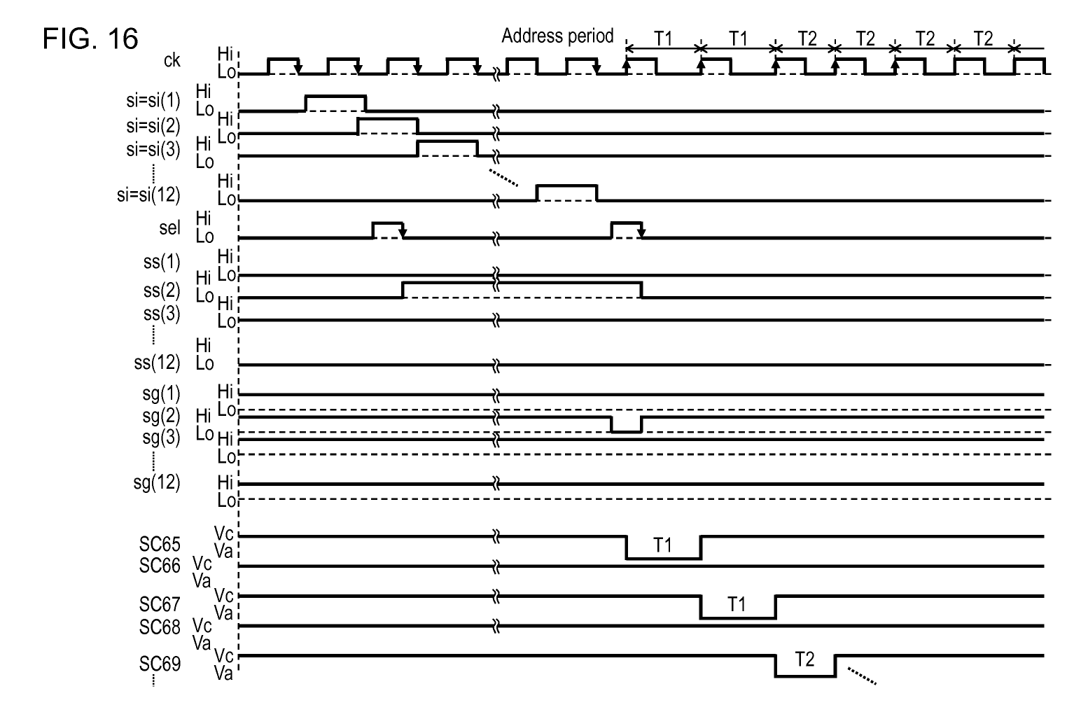

FIG. 16 is a timing chart illustrating the operation of scan IC selecting section 52 of the scan ICs of plasma display apparatus 30 in accordance with the exemplary embodiment of the present invention. FIG. 16 shows a timing chart when the second scan IC, namely IC(2), is selected, for example.

First, selection scan signal si having a pulse width of one clock cycle is input as data input signal si(1) of IC(1) from control signal generation circuit 35. At this time, the signal is delayed by one clock cycle by flip flop FF2(1) in IC(1), and is input as data input signal si(2) of IC(2). Hereinafter, similarly, the signal is delayed by one clock cycle and input as data input signal si(3) through input signal si(12) of IC(3) through IC(12).

The selection of scan ICs is determined by the falling timing of selection signal sel output from control signal generation circuit 35. Pulse-like selection signal sel is input into each scan IC with the timing when the selection scan signal is input into the scan IC to be selected. With the falling timing of selection signal sel, selection scan signal si(1) through selection scan signal si(12) of respective scan ICs are latched into flip flop FF1(1) through flip flop FF1(12) of IC(1) through IC(12). In FIG. 9, selection signal sel is input with the timing when address start signal si(2) is input into the second scan IC, so that only output signal ss(2) of flip flop FF1(2) is at the “H” level and the other output signal ss(1) and output signal ss(3) through output signal ss(12) are at the “L” level.

Then, after selection scan signal si(12) is input into the 12th scan IC and signal so(12) delayed by one clock cycle by flip flop FF2(12) is output, pulse-like selection signal sel including one rising of clock ck is input into each scan IC. At this time, output sg(2) of NAND gate G1(2) of IC(2) is at the “L” level only for a period including one rising of clock ck. Output sg(1) and output sg(3) through output sg(12) of NAND gate G1(1) and NAND gate G1(3) through NAND gate G1(12) of the other scan ICs are kept at the “H” level. With the falling timing of selection signal sel, all of output signal ss(1) through output signal ss(12) of flip flop FF1(1) through flip flop FF1(12) of IC(1) through IC(12) come to the “L” level.

Thus, single pulse signal sg(2) that is at the “L” level only for a period including one rising of clock ck is input into only shift resistor SR(2) of the second scan IC. Then, whenever clock ck is input, shift resistor SR(2) sequentially shifts single pulse signal sg(2). At this time, when control signal c0 is set at the “H” level, scan pulses are sequentially applied to the scan electrodes in the order of scan electrode SC65, scan electrode SC67, . . . , scan electrode SC127, scan electrode SC66, scan electrode SC68, . . . , and scan electrode SC128. When the clock cycle corresponding to the scan pulses applied to scan electrode SC65, scan electrode SC67, scan electrode SC66, and scan electrode SC68 is assumed to be time T1, and the clock cycle corresponding to the other scan pulses is assumed to be time T2, the scan pulses of a desired pulse width can be obtained.

The above-mentioned driver circuit shows one example, and the present invention is not limited to the configurations of the above-mentioned driver circuits.

The specific numerical values of the present embodiment are simply one example, preferably are set optimally in response to the characteristic of the panel and the specification of the plasma display apparatus.

### INDUSTRIAL APPLICABILITY

The present invention provides a driving method for a plasma display panel and a plasma display apparatus where a stable address discharge is performed and scan pulses for reducing the electric power of the data electrode driver circuit can be switched even in a high-definition and large-screen panel. Therefore, the present invention is useful for a driving method for a panel and a plasma display apparatus.

### REFERENCE MARKS IN THE DRAWINGS

10 panel
12 scan electrode
13 sustain electrode
22 data electrode
30 plasma display apparatus
31 image signal processing circuit
32 data electrode driver circuit
33 scan electrode driver circuit
34 sustain electrode driver circuit
35 control signal generation circuit
41 initializing voltage generating section
42 sustain pulse generating section
43 scan pulse generating section
51 switching element control section
52 scan IC selecting section

1. A method for driving a plasma display panel that includes a plurality of discharge cells each of which has a data electrode and a display electrode pair formed of a scan electrode and a sustain electrode, wherein the plasma display panel is driven with a structure of one field including a plurality of subfields each of which has an address period and a sustain period, the method comprising the steps of:
dividing an image display region into a plurality of partial display regions each having a given number of scan electrodes continuously disposed;
dividing the scan electrodes in each partial display regions into two groups, namely, one group formed of odd-numbered scan electrodes and another group formed of even-numbered scan electrodes,
applying scan pulses sequentially to the one group, and then applying scan pulses sequentially to the another group;
setting a pulse width of scan pulses applied to a first through a given numbered scan electrode of the one group to be longer than a pulse width of scan pulses applied to remaining scan electrodes of the one group, and
setting a pulse width of scan pulses applied to a first through a given numbered scan electrode of the another group to be longer than a pulse width of scan pulses applied to remaining scan electrodes of the another group.

2. The method for driving the plasma display panel of claim 1, wherein
percentage of the number of discharge cells to be lit is detected as a partial lighting rate in each partial display region, and a scan pulse is applied to the partial display regions, firstly to a partial display region of the highest partial lighting rate.

3. A plasma display apparatus comprising:
a plasma display panel that has a plurality of discharge cells each of which has a display electrode pair formed of a scan electrode and a sustain electrode, and a data electrode; and
a driver circuit that forms one field using a plurality of subfields each of which has an address period and a sustain period, and drives the plasma display panel,
wherein
the driver circuit includes a plurality of scan ICs for applying scan pulses to a predetermined number of scan electrodes disposed continuously,
scan electrodes driven by one of the scan ICs are divided into two scan electrode groups: a scan electrode group formed of an odd-numbered scan electrodes; and a scan electrode group formed of an even-numbered scan electrodes,
the scan IC sequentially applies scan pulses to one scan electrode group of the two groups, and then sequentially applies scan pulses to another scan electrode group of the two groups,
a pulse width of scan pulses applied to a first through predetermined-numbered scan electrodes belonging to the one scan electrode group is set to be longer than a pulse width of scan pulses applied to remaining scan electrodes belonging to the one scan electrode group, and
a pulse width of scan pulses applied to the first through predetermined-numbered scan electrodes belonging to the another scan electrode group is set to be longer than pulse width of scan pulses applied to remaining scan electrodes belonging to the another scan electrode group.
